(19) United States
(12) Patent Application Publication
(10) Pub. No.: US 2008/0005971 A1
(43) Pub. Date: Jan. 10, 2008

(54) Single Rail No Pulley Window Regulator

(76) Inventors: Robert Boyer DICKIE, Canton, MI (US); David Lawrence Newkirk, Sterling, MI (US); Troy Donavan Allan, Howell, MI (US); Douglas Chester Carson, Brighton, MI (US); Robert Brady Mooney, Farmington Hills, MI (US)

Correspondence Address: MAGNA INTERNATIONAL, INC., 337 MAGNA DRIVE, AURORA, ON, L4G-7K1, US

(21) Appl. No.: 11/765,680

(22) Filed: Jun. 20, 2007

Related U.S. Application Data
(60) Provisional application No. 60/815,522, filed on Jun. 21, 2006.

(51) Int. Cl. E05F 15/00

(52) U.S. Cl. 49/349

(57) ABSTRACT

A window regulator is provided for operating a window pane of an automotive vehicle including a guide rail extending between opposite upper and lower ends. A lifter plate is slidably coupled to the guide rail. The lifter plate includes an integrated drum housing and is adapted for supporting the window pane. A motor assembly is fixedly secured to the lifter plate and includes a drive housing and a reversible motor. A drive shaft is rotatably coupled to the drive housing for rotation by the reversible motor. A cable drum is disposed in the integrated drum housing of the lifter plate for being rotatably driven by the drive shaft. A pair of cables having first ends connected to the cable drum are at least partially wound around the cable drum in opposite directions while second ends are connected to the upper and lower ends of the guide rail. The lifter plate, cable drum and motor assembly move together upwardly and downwardly along the guide rail in response to rotation of the shaft.

This application claims the benefits of U.S. Provisional Application No. 60/815,522.

### BACKGROUND OF THE INVENTION

1. Field of the Invention

The present invention relates to a window regulator and, more particularly, to a single rail no pulley window regulator for use in an automotive vehicle.

2. Description of Related Art

Cable driven window regulators in an automotive vehicle commonly include a closed loop cable for transferring a force supplied by a reversible motor to lift or lower a window pane. Opposing ends of the cable are secured to a cable drum and the cable is typically wound around the cable drum which is rotationally driven by the motor. The cable is also guided around upper and lower pulleys supported by opposing ends of a guide rail. A lifter plate is slidably coupled to the guide rail and attached to the cable between the upper and lower pulleys. The window pane is secured to the lifter plate such that the window pane is lifted or lowered by movement of the lifter plate along the guide rail between the upper and lower pulleys. An example of this type of window regulator is disclosed in U.S. Pat. No. 5,074,077 to Toyoshima et al.

Cable driven window regulators as described above are complex and comprised of many components. Consequently, it is desirable to provide a window regulator which can be made from only a few parts that can be produced and assembled cost-effectively.

### SUMMARY OF THE INVENTION

According to one aspect of the invention, there is provided a window regulator for operating a window pane of an automotive vehicle including a guide rail extending between opposite upper and lower ends. A lifter plate is slidably coupled to the guide rail. The lifter plate includes an integrated drum housing and is adapted for supporting the window pane. A motor assembly is fixedly secured to the lifter plate and includes a drive housing and a reversible motor. A drive shaft is rotatably coupled to the drive housing for rotation by the reversible motor. A cable drum is disposed in the integrated drum housing of the lifter plate for being rotatably driven by the drive shaft. A pair of cables having first ends connected to the cable drum are at least partially wound around the cable drum in opposite directions while second ends are connected to the upper and lower ends of the guide rail. The lifter plate, cable drum and motor assembly move together, upwardly and downwardly along the guide rail in response to rotation of the drive shaft.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a window regulator according to the invention;

FIG. 2 is an exploded perspective view of the window regulator of FIG. 1;

FIG. 3 is an exploded perspective view of a motor assembly, cable drum and cables;

FIG. 4 is partially cut-away, perspective view of a tube socket;

FIG. 5 is an enlarged, perspective view of a back side of a lifter plate; and

FIG. 6 is a perspective view of a second embodiment of a guide rail.

### DETAILED DESCRIPTION OF THE PREFERRED EMBODIMENT

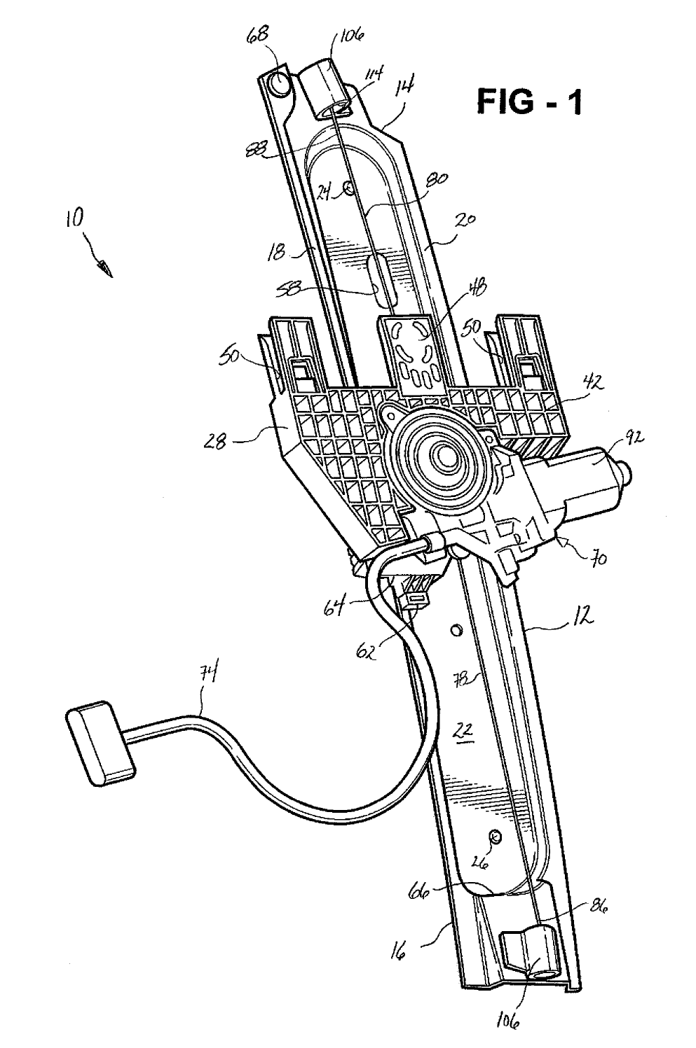

Referring to FIG. 1, a single rail no pulley window regulator is generally shown at 10. The window regulator 10 includes an elongated guide rail 12 extending between an upper end 14 and a lower end 16. Preferably, the guide rail 12 is stamped from sheet metal and is gently curved along its length. Flanges 18, 20 extend along each side of the guide rail 12 while a center section 22 is slightly recessed. Upper 24 and lower 26 mounting holes are provided adjacent the respective upper 14 and lower 16 ends for mounting the window regulator 10 in a door (not shown) of an automotive vehicle (not shown).

The window regulator 10 also includes a lifter plate 28 slidably coupled to the guide rail 12 for movement therealong between the upper 14 and lower 16 ends. More specifically, referring to FIG. 5, a pair of spaced apart slider fingers 30, 32 integrally formed on a back side 34 of the lifter plate 28 are sidably engaged with the flange 18 extending along one side of the guide rail 12. A pair of spaced apart snap fingers 36, 38, also integrally formed on the back side 34 of the lifter plate 28, are slidably engaged with the flange 20 extending along the other side of the guide rail 12. The lifter plate 28 includes an integrated drum housing 40 between the slider fingers 30, 32 and snap fingers 36, 38. The drum housing 40 protrudes from the back side 34 of the lifter plate 28 such that it is partially disposed into the slightly recessed center section 22 of the guide rail 12 when the lifter plate 28 is assembled thereto.

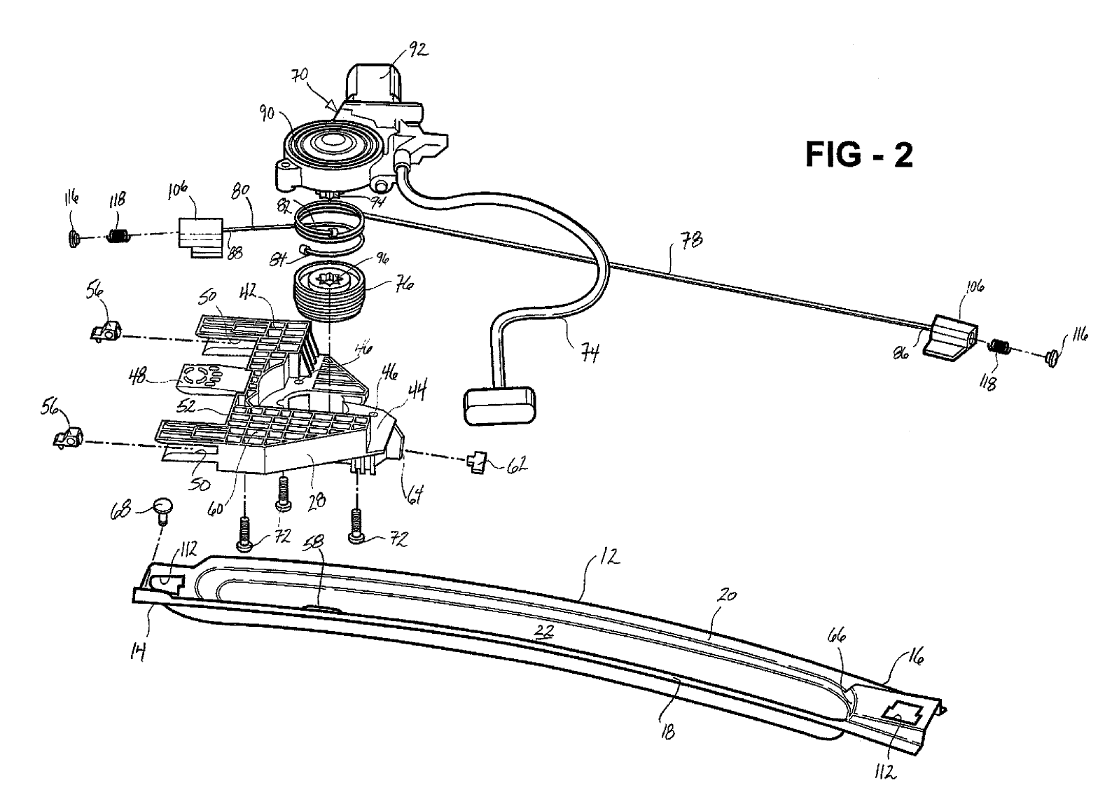

Referring to FIGS. 2 and 5, a front side 42 of the lifter plate 28 includes a smooth mounting surface 44 having three mounting holes 46 disposed therearound extending through the lifter plate 28. Additionally, a snap tab 48 and a pair of upward facing slots 50 are disposed along an upper edge 52 of the lifter plate 28 for securing and supporting a lower portion (not shown) of a window pane (not shown). The snap tab 48 includes a lock feature 54, shown in FIG. 5, for engaging an aperture (not shown) in the lower portion of the window pane. A glass bumper 56, preferably made from santoprene, which is a compressible yet resilient material, is fixedly secured within each upward facing slot 50 for providing a snug fit between the window pane and the upward facing slots 50. An oblong hole 58 in the center section 22 of the guide rail 12 is provided for accessing the snap tab 48 to release the lock feature 54 allowing removal of the window pane for service.

The lifter plate 28 is molded from plastic and includes a plurality of ribs and gussets 60 on the front 42 and back 34 sides forming a lattice structure designed to provide structural integrity to the lifter plate 28. A down-stop bumper 62 is fixedly secured to a lower edge 64 of the lifter plate 28 for abutting a stop 66, shown in FIG. 1, at the lower end 16 of the guide rail 12 when the window pane is fully lowered. In addition, the guide rail 12 includes a hole (not shown) at the upper end 14 thereof for receiving a glass slap bumper 68 to prevent the window pane from rattling when the door is closed and the window pane is partially open.

Referring to FIGS. 1 and 2, the window regulator 10 further includes a motor assembly, generally indicated at 70, seated against the smooth mounting surface 44 of the lifter plate 28 and fixedly secured thereto in opposite facing relationship to the drum housing 40 by three screws 72 extending through the mounting holes 46. Other mounting means such as bolting or riveting may be used to fixedly secure the motor assembly 70 to the lifter plate 28 without varying from the scope of the invention. The motor assembly 70 includes an electrical cable 74 connected thereto for controlling and powering the motor assembly 70. A disc-like cable drum 76 is seated within the drum housing 40 and is in operative engagement with the motor assembly 70 as will be further described hereinbelow.

A first 78 and second 80 cable are provided having opposite first 82, 84 and second 86, 88 ends, respectively, shown in FIG. 2. The first cable 78 extends between the cable drum 76 and the lower end 16 of the guide rail 12 and the second cable 80 extends between the cable drum 76 and the upper end 14 of the guide rail 12, as shown in FIG. 1. Each of the first 78 and second 80 cables are at least partially wound around the cable drum 76. Alternatively, the window regulator 10 may include a single cable connected between the upper 14 and lower 16 ends of the guide rail 12. The single cable is at least partially wound around the cable drum 76 and functions similar to that of the first 78 and second 80 cables.

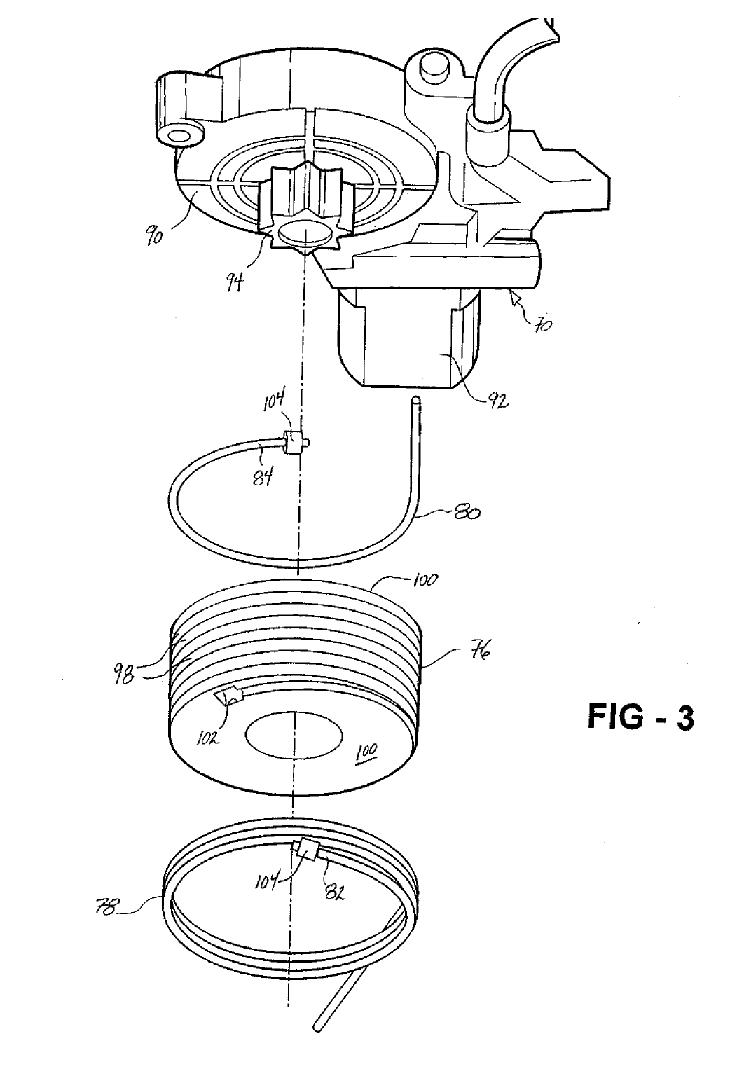

The motor assembly 70 rotates the cable drum 76 in either a clockwise or counterclockwise direction to pull on either the first 78 or second 80 cable and move the lifter plate 28 between the upper 14 and lower 16 ends of the guide rail 12, thereby lowering or lifting the window pane. Specifically, referring to FIG. 3, the motor assembly 70 includes a drive housing 90 supporting a reversible motor 92. A star-shaped drive shaft 94 is coupled to the drive housing 90 for rotation in both the clockwise and counterclockwise direction. The drive shaft 94 engages the cable drum 76.

The cable drum 76 includes a center bore 96, shown in FIG. 2, having a corresponding star-shape for matingly receiving the drive shaft 94, and a series of helical outer perimeter grooves 98 for receiving and winding the first 78 and second 80 cables therearound. The helical grooves 98 taper into each side 100 of the cable drum 76. The helical grooves 98 direct the first 78 and second 80 cables to a pair of recessed pockets 102 (one shown) for receiving and securing a ferrule 104 crimped at the first end 82, 84 of each of the first 78 and second 80 cables.

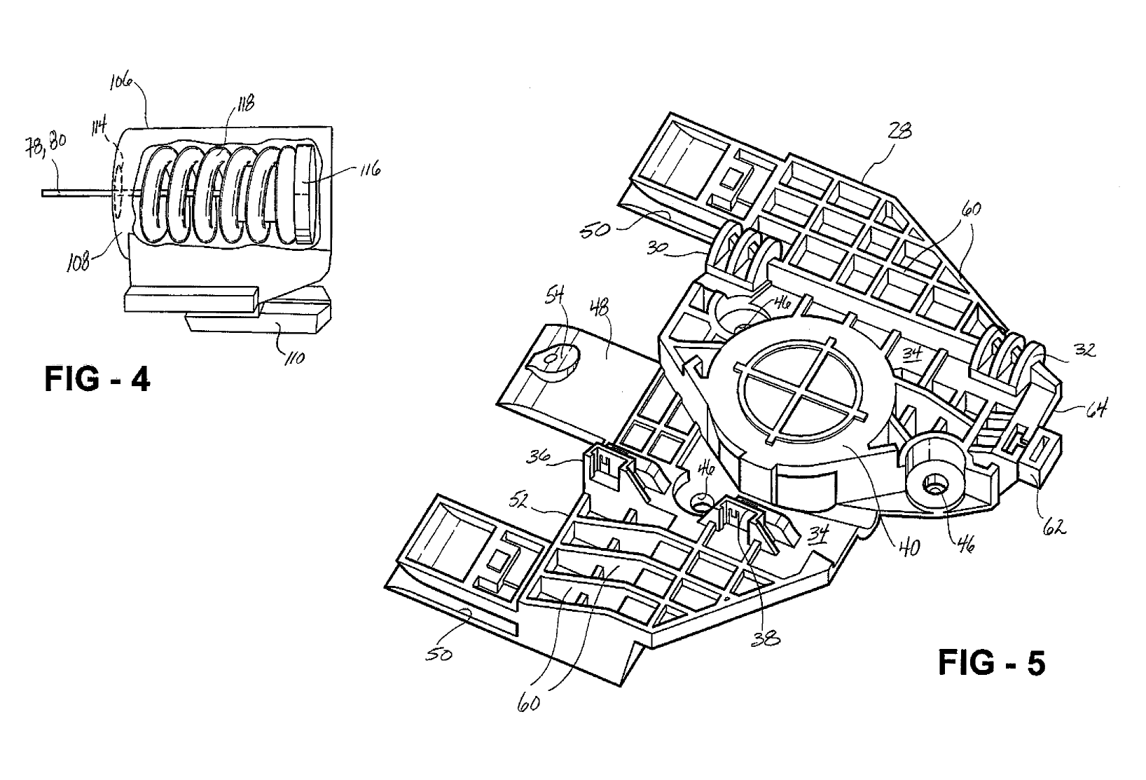

Referring to FIG. 1, a pair of tube sockets 106 is connected to the upper 14 and lower 16 ends of the guide rail 12. More particularly, each tube socket 106 includes a cylindrical housing 108 fixedly secured to a pair of feet 11 0, as shown in FIG. 4. The feet 110 are inserted into an opening 112, shown in FIG. 2, at the upper 14 and lower 16 ends of the guide rail 12 fixedly securing the tube sockets 106 thereto. The cylindrical housing 108 of each tube socket 106 includes a hole 114 at one end, large enough to receive one of the first 78 or second 80 cables therethrough. The hole 114 directs the first 78 and second 80 cables into the respective cylindrical housing 108 for receiving and securing a T-ferrule 116 crimped at the second end 86, 88 of each of the first 78 and second 80 cables. Additionally, a spring 118 is disposed about the second end 86, 88 of each of the first 78 and second 80 cables and extends between the T-ferrule 116 and the cylindrical housing 108. The springs 118 maintain tension in the first 78 and second 80 cables.

The first end 82 of the first cable 78 is fixedly secured to the cable drum 76 and the first cable 78 is partially wound around the cable drum 76, resting within the helical grooves 98, in a clockwise direction (when viewed from FIG. 2). The second end 86 of the first cable 78 is fixedly secured to the tube socket 106 at the lower end 16 of the guide rail 12. Similarly, the first end 84 of the second cable 80 is fixedly secured to the cable drum 76 and the second cable 80 is partially wound around the cable drum 76, resting within the helical grooves 98, in a counterclockwise direction (when viewed from FIG. 2). The second end 88 of the second cable 80 is fixedly secured to the tube socket 106 at the upper end 14 of the guide rail 12.

To assemble the window regulator, the ferrules 104 are crimped onto the first ends 82, 84 of each of the first 78 and second 80 cables. The ferrules 104 are snapped into the recessed pockets 102 on each side 100 of the cable drum 76 and the first 78 and second 80 cables are partially wound around the cable drum 76 in the clockwise and counterclockwise directions, respectively. The cable drum 76 with the first 78 and second 80 cables attached thereto is installed into the drum housing 40 of the lifter plate 28. Next, the tube sockets 106 and then the springs 118 are slid onto the second ends 86, 88 of each of the first 78 and second 80 cables. The T-ferrules 116 are then crimped onto the second ends 86, 88 of each of the first 78 and second 80 cables. The down-stop bumper 62 and glass bumpers 56 are installed into the lift plate 28.

The drive shaft 94 of the motor assembly 70 is inserted into the center bore 96 of the cable drum 76 and the motor assembly 70 is secured to the lifter plate 28 by the mounting screws 72. The tube socket 106 at the second end 86 of the first cable 78 is snapped into the opening 112 at the lower end 16 of the guide rail 12 and the tube socket 106 at the second end 88 of the second cable 80 is snapped into the opening 112 at the upper end 14 of the guide rail 12. The lifter plate 28 is installed onto the guide rail 12 by hooking the slider fingers 30, 32 onto the flange 18 extending along one side of the guide rail 12 and then deflecting the snap fingers 36, 38 to snap onto the flange 20 extending along the other side of the guide rail 12. Finally, the glass slap bumper 68 is installed into the hole at the upper end 14 of the guide rail 12. The window regulator 10 is now ready to be installed into the door of the vehicle.

In a pre-loaded state, with the window regulator 10 filly assembled as shown in FIG. 1, the lifter plate 28 is positioned midway along the guide rail 12 between the upper 14 and lower 16 ends. The predetermined length of the first 78 and second 80 cables will cause the springs 118 to be partially compressed in the cylindrical housing 108 of each tube socket 106. When the motor 92 is powered to rotate the drive shaft 94 and cable drum 76 in the counterclockwise direction (when viewed from FIG. 2), the first cable 78 winds around the cable drum 76 as it rotates, making it shorter, and thus pulls the lifter plate 28 downwardly to lower the window pane. During the downward movement of the lifter plate 28, the spring 118 disposed in the cylindrical housing 108 of the tube socket 106 at the lower end 16 of the guide rail 12 is filly compressed. At the same time, the second cable 80 unwinds from the cable drum 76 as it rotates, making it longer. The spring I 18 disposed in the cylindrical housing 108 of the tube socket 106 at the upper end 14 of the guide rail 12 provides tension to the second cable 80. The window pane is fully lowered when the down-stop bumper 62 at the lower edge 64 of the lifter plate 28 abuts the stop 66 at the lower end 16 of the guide rail 12.

After the down-stop bumper 62 abuts the stop 66 at the lower end 16 of the guide rail 12, the motor 92 stops powering the drive shaft 94 and the cable drum 76 is maintained in its current state. The springs 118 maintain the tension in the first 78 and second 80 cables.

When the motor 92 is reversed to turn the drive shaft 94 and cable drum 76 in the clockwise direction (when viewed from FIG. 2), the opposite movement of the lifter plate 28 occurs. The second cable 80 winds around the cable drum 76 as it rotates, making it shorter, and thus pulls the lifter plate 28 upwardly to raise the window pane. During the upward movement of the lifter plate 28, the spring 118 disposed in the cylindrical housing 108 of the tube socket 106 at the upper end 14 of the guide rail 12 is fully compressed. At the same time, the first cable 78 unwinds from the cable drum 76 as it rotates, making it longer. The spring 118 disposed in the cylindrical housing 108 of the tube socket 106 at the lower end 16 of the guide rail 12 provides tension to the first cable 78. The window pane is fully raised when a top edge (not shown) abuts a rubber window seal (not shown).

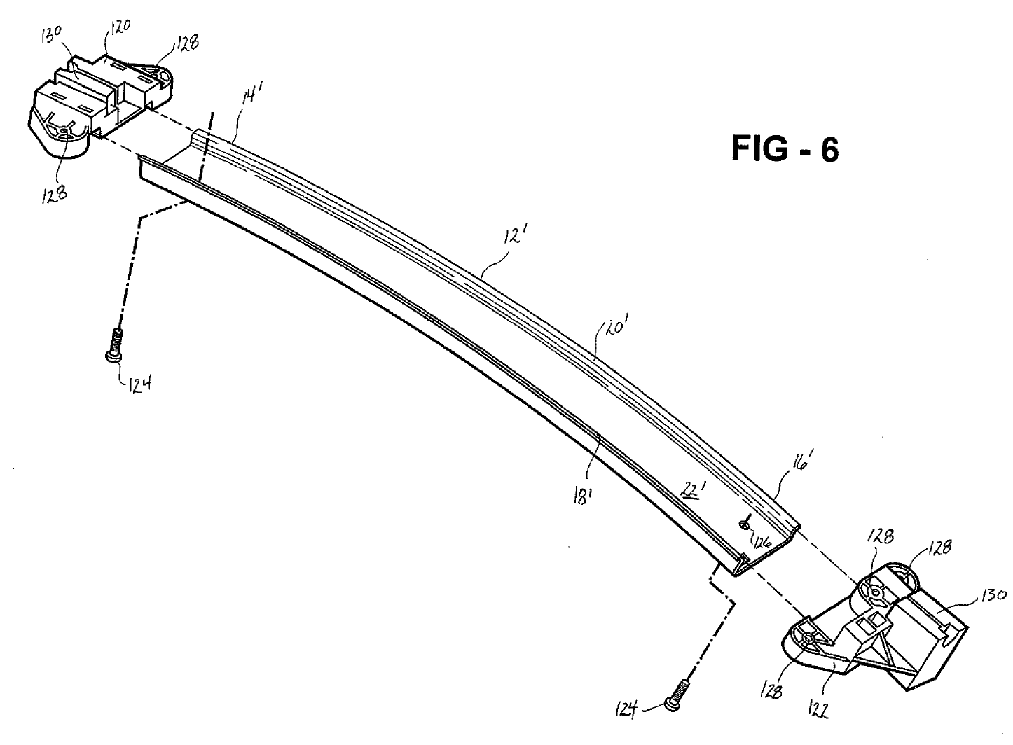

Referring to FIG. 6, wherein like primed reference numerals represent similar elements as those described above, in a second embodiment of the invention the guide rail 12′ is roll formed with molded top 120 and bottom 122 end caps fixedly secured to the upper 14′ and lower 16′ ends by a fastener 124 such as a screw or the like. Flanges 18′, 20′ extend along each side of the guide rail 12′ while a center section 22′ is slightly recessed. Each of the upper 14′ and lower 16′ ends of the guide rail 12′ include a hole 126 (one shown) for receiving the screw 124 to mount the top 120 and bottom 122 end caps. Each of the top 120 and bottom 122 end caps include mounting holes 128 for mounting the window regulator 10′ in the door of the vehicle. In addition, each of the top 120 and bottom 122 end caps include an integrally formed tube socket 130 for receiving and securing the T-ferrule 116′ crimped at the second end 86′, 88′ of each of the first 78′ and second 80′ cables.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed:

1. A window regulator for operating a window pane of an automotive vehicle comprising:
a guide rail extending between opposite upper and lower ends;
a lifter plate slidably coupled to said guide rail, said lifter plate including an integrated drum housing and adapted for being connected to the window pane;
a motor assembly fixedly secured to said lifter plate, said motor assembly including a drive housing and a reversible motor;
a drive shaft rotatably coupled to said drive housing for rotation by said reversible motor;
a cable drum disposed in said integrated drum housing of said lifter plate for being rotatably driven by said drive shaft; and
a pair of cables having first ends connected to said cable drum and at least partially wound around said cable drum in opposite directions and second ends connected to said upper and lower ends of said guide rail and wherein said lifter plate, cable drum and motor assembly move together upwardly and downwardly along said guide rail in response to rotation of said drive shaft to selectively operate movement of the window pane.

2. A window regulator as set forth in claim 1 wherein said guide rail includes an integrated stop for abutting said lifter plate when the window pane is fully lowered.

3. A window regulator as set forth in claim 2 including a pair of tube sockets fixedly secured to said upper and lower ends of said guide rail for receiving and securing said second ends of said pair of cables.

4. A window regulator as set forth in claim 3 wherein each of said pair of tube sockets includes a cylindrical housing having a hole for receiving one of said pair of cables therethrough.

5. A window regulator as set forth in claim 4 including a spring disposed about each of said second ends of said pair of cables for maintaining tension in said pair of cables.

6. A window regulator as set forth in claim 5 including a T-ferrule crimped at each of said second ends of said pair of cables and disposed in said cylindrical housing for securing said second ends therein.

7. A window regulator as set forth in claim 6 wherein said cable drum includes a center bore for receiving said drive shaft therein to mount said cable drum on said drive shaft.

8. A window regulator as set forth in claim 7 wherein said cable drum includes a series of helical outer perimeter grooves for receiving and winding said pair of cables around said cable drum in said opposite directions.
